(19) United States
(12) Patent Application Publication
(10) Pub. No.: US 2021/0323016 A1
(43) Pub. Date: Oct. 21, 2021

(54) KIT TO PROTECT FIXTURES FROM PAINT AND DUST

(71) Applicant: Maxim Isaac, Taylor, MI (US)

(72) Inventor: Maxim Isaac, Taylor, MI (US)

(21) Appl. No.: 17/362,942

(22) Filed: Jun. 29, 2021

Related U.S. Application Data
(60) Provisional application No. 63/045,193, filed on Jun. 29, 2020.

(51) Int. Cl. B05B 12/24; B05D 1/32; E04G 21/30

(52) U.S. Cl. CPC B05B 12/24; E04G 21/30; B05D 1/32

(57) ABSTRACT

A method for protecting a fixture mounted to a wall or ceiling of a building to protect the fixture from dust. The method includes the step of applying a double side adhesive tape over a peripheral side of the fixture. A cover having a narrow elastic peripheral opening is donned over the fixture and the periphery of the cover can adhere to the exposed side of the tape.

### CROSS-REFERENCE TO RELATED APPLICATIONS

This application claims priority from the U.S. provisional patent application Ser. No. 63/045,193, filed on Jun. 29, 2020, which is incorporated herein by reference in its entirety.

### FIELD OF THE INVENTION

The present invention relates generally to a kit having a cover to protect fixtures, and more particularly the present invention relates to a kit for protecting fixtures and accessories mounted to a floor, wall, and ceiling from paint and dust, and a method of use thereof.

### BACKGROUND

Repair and painting are a part of maintaining a building and may include repairing damages and painting the walls and ceilings. Coatings on the walls and ceilings may degrade over time, such as chipping of the paint necessitating the need for repainting the walls and ceilings to restore the aesthetic appearance. However, the maintenance job itself is dirty involving dust and paint specks. Articles from a room being painted can be removed or covered to protect them from dust and paint specks. Fixtures that are mounted to the walls or ceilings generally cannot be removed or it is laborious and time-consuming to remove the fixtures. It is a general practice to cover the fixtures mounted to walls or ceilings. However, covering the fixtures can be a tedious and time-consuming task using custom do-it-yourself type coverings to cover and protect fixtures by using excessive amounts of painter tape and generic plastic tarps which the user cuts to the specific size and shape of the fixture. Besides being time-consuming and laborious, the known methods are inefficient in protecting fixtures and may get released resulting in damage to the fixture.

Thus, a need is appreciated for an efficient method for protective fixtures from dust and specks during repair and paint.

Herein the term fixture(s) connotes to an article and accessories mounted to a wall, ceiling, or floor, and includes lights, switchboards, and like. The term fixture(s) also refer hereinafter to articles and accessories placed on a floor.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a method for covering fixtures and accessories of different shapes and sizes using the disclosed kit.

It is another object of the present invention that the kit is economical to manufacture and use.

It is still another object of the present invention that the kit can quickly and easily be applied to the fixtures.

It is still another object of the present invention that the kit and method of use thereof eliminates the need to remove the fixture.

It is yet another object of the present invention that the kit is reusable.

It is a further object of the present invention that the cover or portion of the cover can be removed for a while and reattached.

It is still a further object of the present invention that the method can provide an airtight seal around the fixture.

It is an additional object of the present invention to provide an all-in-one cap i.e., the cap that has an adhesive liner.

In one aspect, disclosed is a method for covering fixtures to protect against dust and specks. The method includes the steps of providing a kit having a cover and a tape, the cover having a cap body with a continuous elastic peripheral opening.

The method further includes the steps of applying a double side adhesive tape around the peripheral side of the fixture, the side that is adjacent to the surface over which the fixture is mounted. Upon, applying the tape, the cap can be donned over the fixture through the opening, and thereafter the elastic periphery of the cover can adhere to the exposed surface of the double-sided adhesive tape.

In one aspect, the elastic periphery of the cover can include a layer of adhesive, wherein the elastic periphery of the cover can directly adhere to the peripheral side of the fixture. The adhesive layer can be protected by a release liner which can be removed to expose the adhesive layer.

In one aspect, the adhesive of the adhesive layer or the adhesive tape does not leave glue behind on the fixture after the same is removed.

In one aspect, the cap body can be made of a self-adhering material that can adhere to the fixture upon covering.

It is another aspect, the cap can be made of latex or resilient stretchy material with a narrow elastic opening, wherein the cap can stretch over the fixture, wherein the continuous elastic peripheral opening of the cap can fit over the peripheral side of the fixture providing an airtight seal.

In one aspect, the outer surface of the cap can be textured for a better grip, thus permitting to grasp the cover with greasy hands. Alternatively, a layer of slip resistance material can provide the grasp.

In one aspect, the cover can include a sleeve along with the periphery of the cap body and a drawstring extends through the sleeve, where ends of the drawstring extend through an aperture in the sleeve. The two ends of the string can be pulled to fold the periphery of the cap body forming a narrow passage, wherein the sleeve can be tightened over the peripheral side of the fixture.

In one aspect, the tape can be a single-sided or double-sided adhesive tape, wherein the exposed surface of the tape can have one or more grooves for increasing the surface area retaining the peripheral opening of the cover. The groove can be a circumferential groove and one or more such circumferential grooves can be provided parallel to each other. Optionally, the inner surface of the peripheral opening of the cover can have protrusions that fit into the groove of the tape. Still, alternatively, the groves can be provided in the peripheral opening of the cover and the protrusions can be provided in the tape. Still, alternatively, both the exposed surface of the tape and the inner surface of the peripheral opening of the cover can have circumferential ribs/protrusions that may enhance the coupling of the cover to the fixture, wherein the cover can be coupled through adhesive, elasticity, or pulled strings methods.

In one aspect, the double side tape can have one side of adhesive that can be adhered to the fixture. The other side of the tape can have a layer of the first member of the hook and loop fastener. The inner surface of the peripheral opening of the cover can also have the second member of the hook and loop fastener wherein the cover can couple to the tape through the hook and loop fastener.

In one aspect, the tape can have an outer side and an inner side, wherein the outer side can have a layer of the first member of the hook and loop fastener and an end portion of the inner side can have a second member of the hook and loop fastener, the rest portion of the inner side can have a layer of slip-resistant material. The tape can be wrapped over the peripheral side of the fixture, wherein the end portion of the inner side overlaps the outer side for securing the outer side to the inner side. The peripheral opening of the cover has a layer of the second member of the hook and loop fastener.

In one aspect, the method further comprises the application of heat using a heat gun to shrink the cover over the fixture.

In one aspect, the cover can be made form a mesh material that allow air flow for articles that require air flow.

In one aspect, a rubber band or tape can be used to tie excess plastic to keep it from making contact on the walls/ceiling surfaces.

In one aspect, a double-sided tape liner is cut along the middle of the tape so that only half of the tape liner is removed.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1a is a perspective view of a cover of the disclosed kit, according to an exemplary embodiment of the present invention.

FIG. 1b is a side view of the cover shown in FIG. 1a, according to an exemplary embodiment of the present invention.

FIG. 1c shows a tape of the kit, according to an exemplary embodiment of the present invention.

FIG. 2 is another exemplary embodiment of the cover, according to the present invention.

FIG. 3a is a perspective view of another exemplary embodiment of the cover, according to the present invention.

FIG. 3b is a side view of the cover shown in FIG. 3a, according to an exemplary embodiment of the present invention.

FIG. 4a is a perspective view of another exemplary embodiment of the cover, according to the present invention.

FIG. 4b is a side view of the cover shown in FIG. 4a, according to an exemplary embodiment of the present invention.

FIG. 5a shows a tape having a groove, according to an exemplary embodiment of the present invention.

FIG. 5b shows a side view of the tape shown in FIG. 5a, according to an exemplary embodiment of the present invention.

FIG. 6 shows another embodiment of square shape cover, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a kit for covering fixtures mounted to walls and ceilings for temporary protection against dirt and specks, such as during repair and paintwork. The kit has a flexible cover that can accommodate the fixtures of a range of shapes and sizes. Moreover, kits of different sizes can be provided to encompass all shapes and size fixtures common in buildings, such as residential, commercial, warehouse, offices, and like. Moreover, the disclosed kit does not hinder the functionality of the fixture and can be reused in the same building or other building resulting in decreased cost and less wastage. Additionally, both time and cost of labor are saved by providing a quick and easy solution to protectively cover the fixtures.

The fixtures can include, but not limited to, door handles, deadbolts, switches, outlets, bathroom accessories, such as toilet paper holders/hooks/towel holders, light fixtures, thermostats, smoke detectors, fire sprinkler heads, supply/return air grills, furniture, artwork, house decorations, etc.

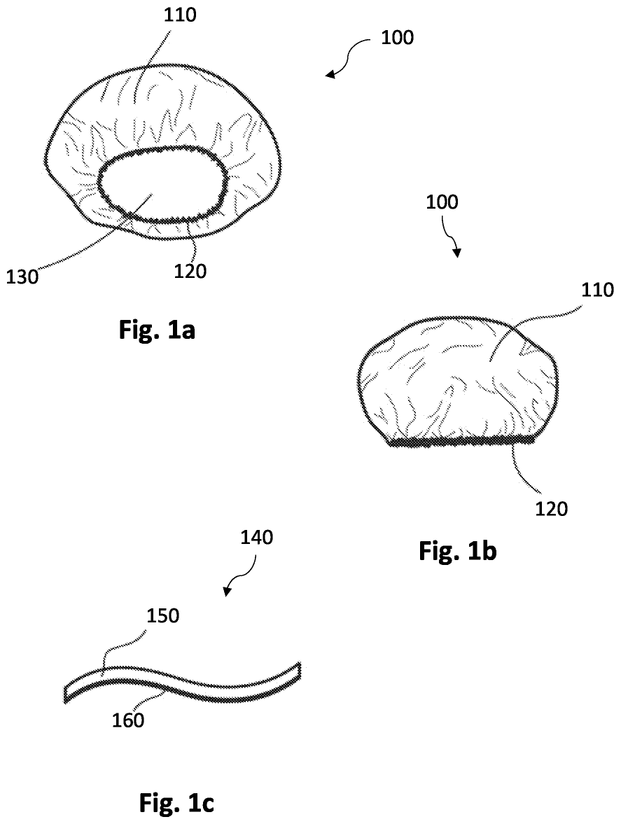

Referring to FIG. 1a-1c which shows an exemplary embodiment of the cover and tape of the disclosed kit. The kit can include a cover to protectively cover a fixture and a tape to couple the cover to the fixture. The tape can be separate or coupled to the cover and both embodiments are within the scope of the present invention. Cover 100 can have a cap body 110 with a narrow opening 130 having a continuous peripheral lining of elastic 120. The cap body can be in the form of a sack with an elastic peripheral opening. The cap body can be made from materials like latex, and plastic. Preferably, the cap body can be transparent that may allow viewing the fixture covered by the disclosed cover. However, translucent, and opaque covers are within the scope of the present invention. The continuous elastic peripheral opening can be formed by a continuous lining of an elastic band along the periphery of the cap body, such as the peripheral narrow opening can be stretched to put on the cover over the fixture and upon being donned, the elastic opening can stretch fit around a peripheral side edge of the fixture.

FIG. 1c shows an exemplary embodiment of the tape 140 having an outer side and an inner side. For example, the tape can be a double side adhesive tape. Disclosed is a method for protectively covering the fixtures mounted to walls and ceilings. The tape can adhere around the peripheral side of the fixture. This is the side of the fixture of which the edge can be in contact with the surface on which the fixture is mounted. For example, the side of the fixture can be adjacent and upstanding from the wall or ceiling. The double tape can be wrapped around the side of the fixture. The cover can then be donned over the fixture. The exposed surface/outer side of the tape can be protected by a release liner. In case the tape is having a release liner the same can be removed. Thereafter, the peripheral opening can stretch fit over the peripheral side of the fixture and forms an airtight seal by bonding to the adhesive. In case the tape is coupled to the periphery of the cover, the elastic peripheral opening of the cover can stretch fit over the side of the fixture. The adhesive helps to both retain the cover over the fixture and forms an airtight seal. The airtight seal can prevent the ingress of dust into the cover during repair, remodeling, and like maintenance activity of a building.

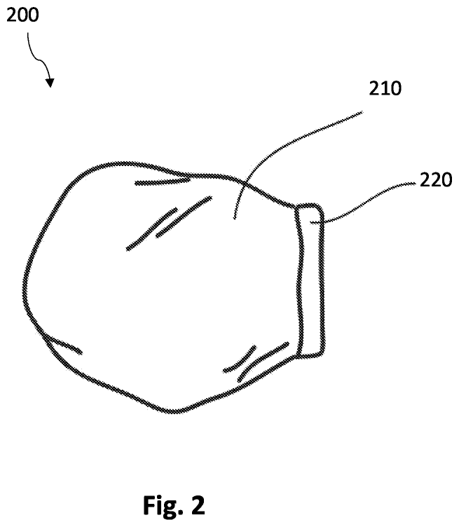

FIG. 2 shows an alternate embodiment of the cover 200 having an elongated cap body 210 with a broader continuous elastic band 220 along the periphery. A layer of adhesive can be applied over the exposed surface of the elastic band 220, wherein the adhesive layer can be temporarily protected by a release liner. However, the elastic band 220 can also be made from a slip-resistant material that can couple to the side of the fixture without any adhesive. Still, alternatively, the elastic band can adhere to the exposed adhesive side of the double-sided adhesive tape.

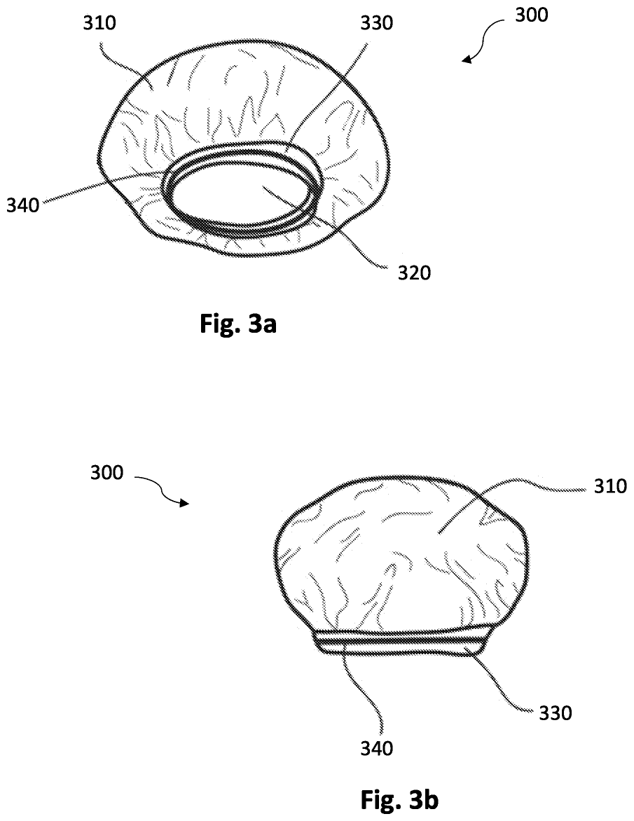

FIGS. 3a and 3b still show an alternate embodiment of the disclosed cover 300 of the kit. The cover 300 can be made from a round sheet of non-porous material, preferably transparent or translucent, forming a cap body 310 having a continuous elastic strap 330 along the periphery of the round sheet forming a narrow stretchable opening 320. The periphery can be wider to provide more area to bond with an adhesive layer of the tape. A circumferential groove or ridge 340 can also be provided that may enhance the retention of the cover at the peripheral side of the fixture. Similar ridge or groove can also be provided on the tape, such as to provide ridge to groove, groove to ridge, or ridge to ridge interlocking between the cover and the tape.

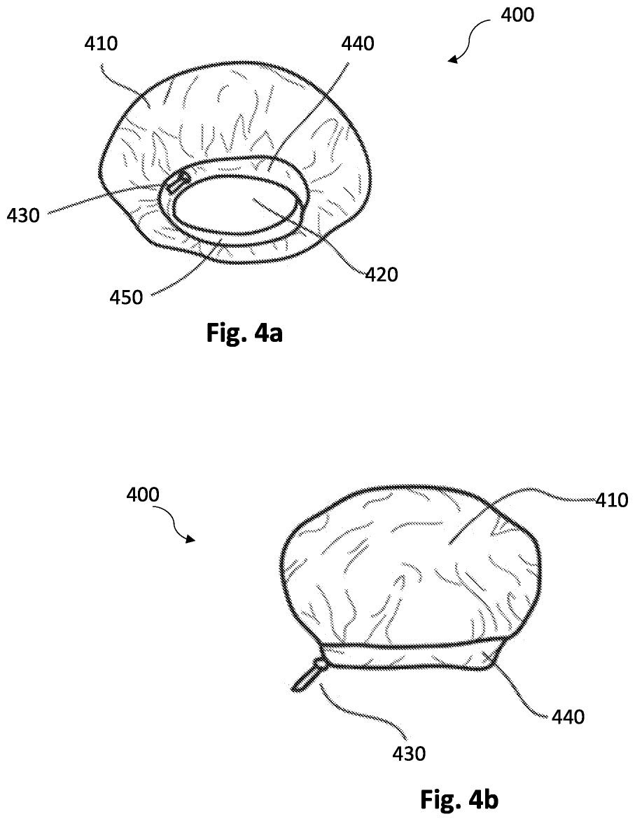

Referring to FIGS. 4a and 4b showing an exemplary embodiment of the cover of the kit. The cover having the cover body 410 of a round sack resembling a balloon. A narrow peripheral opening 420 is formed by a drawstring 430 running through the sleeve 440. The sleeve 440 can be provided along a periphery of a round sheet. The sleeve can be folded by tightening the drawstring resulting in the formation of the cap body 410 of the round sheet. The sleeve can have a hole through which an end of the drawstring can be inserted and extends through the length of the sleeve and can come out through the same hole or a second hole. The drawstring can be loosened to expand the opening 420 and can be tightened to narrow the opening. Such a cover can be donned over the fixture while the opening is expanded by loosening the drawstring. Once donned, the drawstring can be tightened such as the periphery of the cover tightens over the peripheral side of the fixture. The double side adhesive tape can be applied to the peripheral side of the fixture over which the peripheral opening of the cover can bond for an airtight seal.

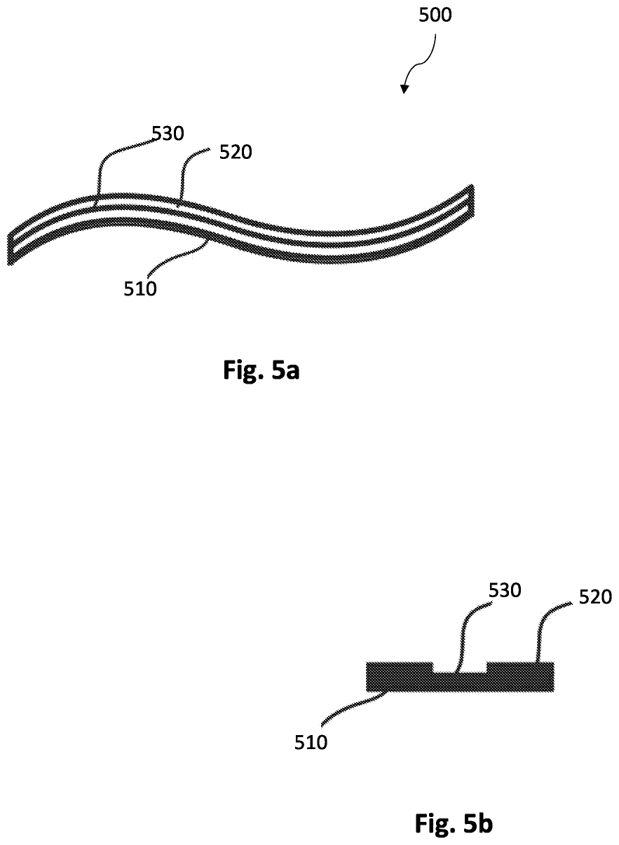

Referring to FIG. 5a which shows an exemplary embodiment of the tape 500 having an inner side 510 and an outer side 520. The outer side 520 can have grove 530 running along the length of the tape. FIG. 5b is an enlarged view showing the groove 530. The groove may provide enhanced coupling of the peripheral of the cover to the tape. The peripheral opening of the cover can have a circumferential rib that can be interlocked in the groove 530.

The double side adhesive tape can have an adhesive that may not leave any residue adhesive or mark on the surface of the fixture. Moreover, the cover can be easily removed from the adhesive tape and can be reused. The adhesive can be such that the adhesive tape can be reused. In case, the adhesive tape can be provided on the inner side of the peripheral opening of the cover, the adhesive can be preferably reusable, such as pressure-sensitive adhesive are known that can be reused again.

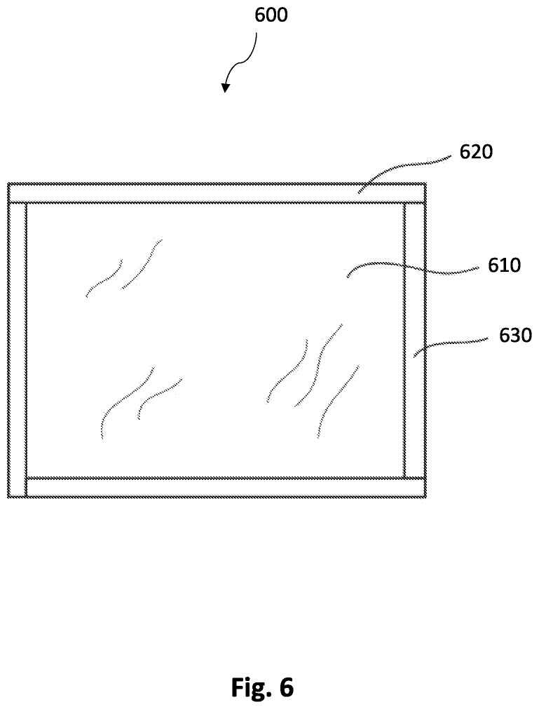

FIG. 6 shows an alternative embodiment of the cover 600 that has a square shape cap body 610 with adhesive liner 620 and 630 along a periphery of the cap body.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for protecting a fixture mounted to a surface, the fixture having a side that is upstanding relative to the surface, the method comprising the steps of:
providing a kit comprising:
a tape has an inner side and an outer side, both the inner side and the outer side having an adhesive, the outer side protected by a release liner, and
a cover has a cap body and a continuous elastic peripheral opening, the cover configured to be donned over the fixture;
applying the inner side of the tape over the side of the fixture;
donning the cover over the fixture through the continuous elastic peripheral opening; and
releasing the continuous elastic peripheral opening of the cover over the side of the fixture, such as the continuous elastic peripheral opening adheres to the outer side of the tape.

2. The method according to claim 1, wherein the adhesive on the outer side of the tape permits releasing the continuous elastic peripheral opening of the cover such as the cover can be reused.

3. The method according to claim 1, wherein the cover comprises an elastic band running along with the continuous elastic peripheral opening, wherein a width of the elastic band is commensurate with a width of the tape.

4. The method according to claim 1, wherein the cover is transparent.

5. The method according to claim 4, wherein an outer surface of the cover has a texture for grip.

6. The method according to claim 4, wherein an outer surface of the cover has a slip-resistant layer for grasp.

7. The method according to claim 1, wherein the cap body is a round sheet that has a continuous elastic lining along a periphery forming the continuous elastic peripheral opening.

8. The method according to claim 1, wherein the outer side of the tape has a continuous circumferential groove.

9. The method according to claim 8, where an inner surface of the continuous elastic peripheral opening has a continuous circumferential rib.

10. A method for protecting a fixture mounted to a surface, the fixture having a side that is upstanding relative to the surface, the method comprising the steps of:
providing a cover, the cover has a cap body and a continuous elastic peripheral opening, the cover configured to be donned over the fixture, a tape coupled to an inner surface of the continuous elastic peripheral opening, an exposed surface of the tape has a layer of adhesive, the layer of adhesive protected by a release liner;
donning the cover over the fixture through the continuous elastic peripheral opening;
upon donning the cover, removing the release liner; and
upon releasing the release liner, adhering the continuous elastic peripheral opening to the side of the fixture forming an air tight seal.
